(19) United States
(12) Patent Application Publication
(10) Pub. No.: US 2021/0053257 A1
(43) Pub. Date: Feb. 25, 2021

(54) UV CURING ASSEMBLY

(71) Applicant: HIX CORPORATION, Pittsburg, KS (US)

(72) Inventor: Phillip D. Ward, Frontenac, KS (US)

(21) Appl. No.: 16/999,274

(22) Filed: Aug. 21, 2020

Related U.S. Application Data
(60) Provisional application No. 62/889,822, filed on Aug. 21, 2019.

(51) Int. Cl. B29C 35/08; G01K 3/00

(52) U.S. Cl. CPC B29C 35/0805; B29C 2035/0827; G01K 3/005

(57) ABSTRACT

The present invention provides an improved UV curing assembly comprising an exposure unit configured for receiving a support substrate, a support structure extending from said exposure unit and configured for housing a vacuum source, a flexible membrane cover configured to cover said exposure unit and in pneumatic communication with said vacuum source, a lower receptacle, said lower receptacle configured for receiving an LED array, said LED array having a first terminal and a second terminal, a first plurality of LEDs having a first characteristic connected in series, a second plurality of LEDs having a second characteristic connected in series, and said first plurality of LEDs and said second plurality of LEDs connected in parallel to said first terminal and said second terminal wherein said first plurality of LEDs and said second plurality of LEDs are capable of treating a material placed on said support substrate.

### FIELD OF THE INVENTION

The present invention is broadly directed to ultraviolet (UV) curing devices which are used in processing curable materials and more particularly, to a UV curing assembly which includes a UV light emitting diode exposing unit with a plurality of solid-state emitters to treat a UV light sensitive emulsion or coating when brought within the operational range of the exposing unit.

### BACKGROUND OF THE INVENTION

Ultraviolet light is used in a variety of manufacturing processes to treat surfaces, screens, films, coatings and other coated surfaces for various purposes including corrosion resistance, decoration or surface protection (e.g. scratch resistance). The surfaces, screens, films and coatings typically utilize a resin or polymer-based material which is applied to the surface and which become solid in responsive to the receipt of radiant energy. In some cases, the radiant process is slow and requires extensive times to solidify the material. In addition, in some cases, the thermal energy may damage some of the treated materials.

Over the years, there have been a number of different methods to generate radiant energy needed to treat the surfaces, screens, films and coatings. Some prior attempts to generate the necessary radiant energy include the use of Carbon Arc, Mercury Vapor Lamps, Metal Halide Lamps, Fluorescent Lamps and most recently Light Emitting Diodes (LEDs).

LED's offer some advantages to the other radiant sources, but they have some disadvantages as well. LED's typically emit a very narrow bandwidth of light, normally from ±5 nm to ±10 nm from its peak luminance emittance wavelength. Exposure unit devices using only a single wavelength LED require a light sensitive emulsion that is engineered to work in conjunction with the wavelength of that particular LED. This provides less flexibility and takes additional planning, engineering and cost. Emulsions also benefit from wider bandwidth of light than a single wavelength LED can produce by producing faster exposure times and more complete curing. This invention solves this problem by incorporating a selection of different nm wavelength emitting LEDs and groups them into a common array to provide a larger bandwidth of UV light.

In addition, the use of a “strips” or “clusters” of lights such as those found in fluorescent lamps and many other current LED units have design problems. Because of these problems, exposing emulsions with a design will have less undercutting with a single point light source. Positioning the single point light source, a distance from the stencil and emulsion coated mesh or plate can perform better than strips or clusters of lights placed in close proximity to the stencil and mesh or plate. Light sources improperly spaced, for example, in close proximity to the stencil and emulsion coated mesh or plate allows the UV light to leak around the stencil edges causing more undercutting. Therefore, there is a need for a solution which incorporates multiple wavelength emitting LED's properly spaced from the area to be exposed.

During the operation of the exposure unit, static electricity can build up due to the frictional contact between the various components. In addition, static charge can build up when working with dielectric materials or when charging a material surface. Static charge is generally present to some degree and difficult to avoid when working with non-conductive materials. If the static charge is allowed to build-up, it can interfere with the process, injure a user or cause undesirable surface contamination.

Currently, there is a need for a solution which incorporates the use of multiple wavelength emitting LED's properly spaced from the area to be exposed which addresses at least a portion of the aforementioned shortcomings described above.

### SUMMARY OF THE INVENTION

One embodiment of the current invention includes an improved UV curing assembly comprising an exposure unit configured for receiving a support substrate, a support structure extending from said exposure unit and configured for housing a vacuum source, a flexible membrane cover configured to cover said exposure unit and in pneumatic communication with said vacuum source, a lower receptacle, said lower receptacle configured for receiving an LED array, said LED array having a first terminal and a second terminal, a first plurality of LEDs having a first characteristic connected in series, a second plurality of LEDs having a second characteristic connected in series, and said first plurality of LEDs and said second plurality of LEDs connected in parallel to said first terminal and said second terminal wherein said first plurality of LEDs and said second plurality of LEDs are capable of treating a material placed on said support substrate.

Various objects and advantages of the present invention will become apparent from the following description taken in conjunction with the accompanying drawings wherein are set forth, by way of illustration and example, certain embodiments of this invention. The drawings submitted herewith constitute a part of this specification, include exemplary embodiments of the present invention, and illustrate various objects and features thereof.

### BRIEF DESCRIPTION OF THE DRAWINGS

FIG. 1 is a side perspective of an embodiment of an UV curing assembly in an open position.

FIG. 2 is a top plan view of an embodiment of an LED array for use in an embodiment of the UV curing assembly of FIG. 1.

FIG. 3 is a bottom plan view of an embodiment of the LED array in accordance with the LED array of FIG. 2.

FIG. 4 is a side perspective of an embodiment of the LED array connected to a lower receptacle for use in an embodiment of the UV curing assembly of FIG. 1.

FIG. 5 is a side perspective of an embodiment of the UV curing assembly in the open position in receipt of a support substrate.

FIG. 6 is a side perspective magnified view of an embodiment of the UV curing assembly of FIG. 5 in the closed position.

FIG. 7 is a side perspective of an embodiment of the UV curing assembly of FIG. 6 in the closed position during operation of suction source.

FIG. 8 is a rear perspective of an embodiment of the UV curing assembly of FIG. 7.

### DETAILED DESCRIPTION OF THE INVENTION

As required, a detailed description of the present invention is disclosed herein; however, it is to be understood that the disclosed description provided is merely an example of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to the drawings in more detail, the reference numeral 10 generally refers to an embodiment of the present invention, a UV curing assembly which is generally sealable and includes an exposure unit 20 with an exposing chamber 21, and a flexible membrane cover 22 which is used to cover the exposing chamber 21, sealing the exposure unit 20. The exposure unit 20 is generally connected to a support structure 24 which provides stability and vertical support for the exposure unit 20 during operation.

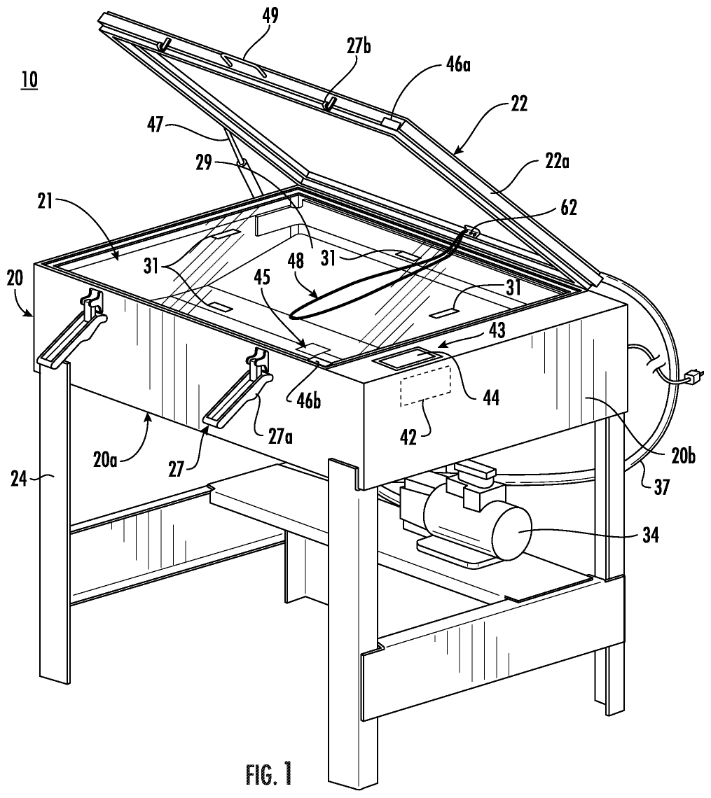

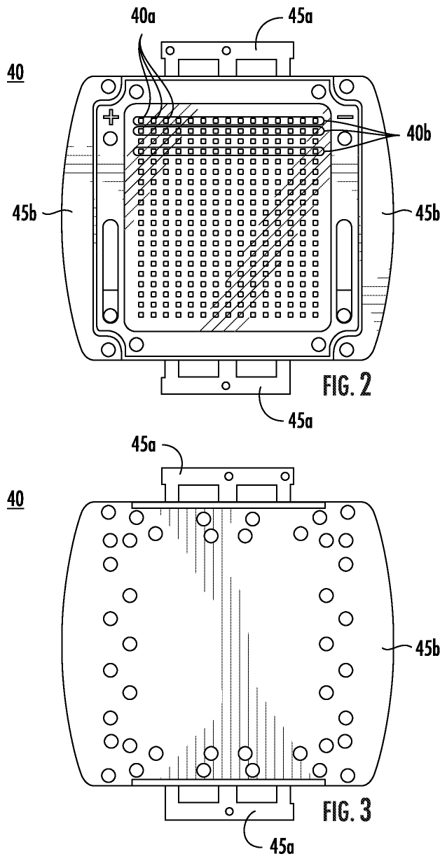

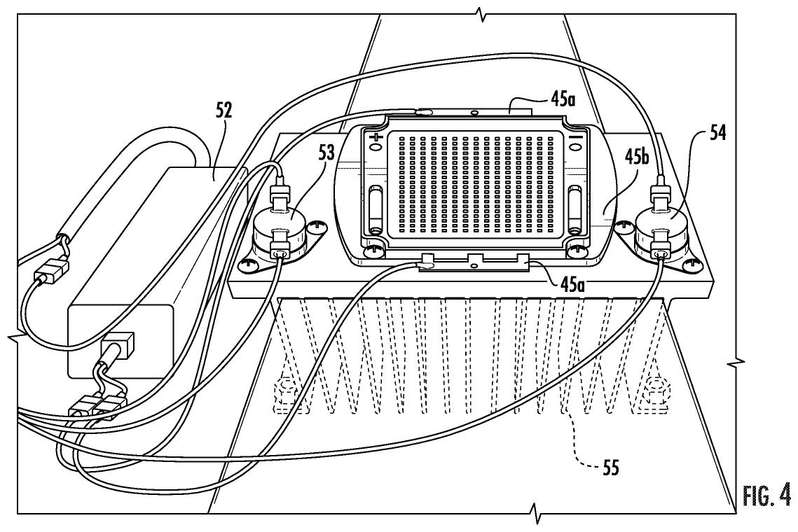

One embodiment of the exposing unit 20 depicted in FIG. 1 is generally rectangularly shaped with a lower support 20a configured for connection to the support structure 24 and a circumferential sidewall 20b extending from the lower support 20a and presenting the exposing chamber 21. The exposing chamber 21 is generally configured for illuminated receipt of a support substrate 30, illustrated in FIG. 5, by the LED array 40 illustrated in FIGS. 2-4.

A lower receptacle 45 extends upwardly from the lower support 20a and is configured for removable receipt of the LED array 40. The lower receptable 45 provides for electrical communication with the controller 42 by the pair of electrical terminals 45a. In addition, the lower receptable 45 includes a mounting support 45b which secures the LED array 40 to the exposing unit 20. The mounting support 45b may also include various heat transfer components to help absorb heat from the LED array 40 mounted to the mounting support 45b with a plurality of downwardly depending structures or fins 55. In operation, excess heat may be conducted from the LED array 40 to the fins 55 for the dissipation of any absorbed heat. In addition, a thermostat or temperature regulator 53, 54 in operation with a fan or blower (not shown) may be utilized to help circulate cooling air as desired.

In the embodiment depicted in FIG. 1, the support structure 24 also provides sufficient mounting structure for securing a power supply (not shown), and a controller 42, with or without a microprocessor (not shown) and a suction source 34 like a vacuum pump. Generally, the vacuum pump 34 is in pneumatic communication with a flexible membrane cover 22 which may be fabricated from neoprene, rubber or some other flexible resilient material for covering the exposure unit 20 during operation. Generally, the flexible membrane cover 22 decreases the ambient pressure and encloses the support substrate 30 during the curing process. The support substrate 30 may include a screen, plate or other generally planar support for receiving the emulsified material 33. Generally, the vacuum pump 34 includes a vacuum block valve 36 having a pair of openings one end associated with a vacuum inlet (not shown) on the vacuum pump 34 and another opening configured for receipt of a vacuum tube 37 extending between the vacuum pump 34 and the flexible membrane cover 22.

A static neutralizer 48 is illustrated in FIG. 1. Generally, the static neutralizer 48 is a flexible member which extends between the exposure unit 20 and the support substrate 30 to help neutralize or equalize any electrical buildup. In some cases, the static neutralizer 48 may collect and conduct electrical charges from one location to another. In another case, the static neutralizer 48 may dissipate the buildup of electrical charges. In operation, the static neutralizer 48 depicted in FIG. 5 provides for electrical connectivity between the flexible membrane cover 22 and the support substrate 30. The static neutralizer 48 electrically equalizes the support substrate 30 and any contained material substrates with the exposing unit 20, thereby limiting the electrical buildup. The flexible static neutralizer 48 provides more points of contact to help neutralize any charge buildup.

An evacuation passage 60 extends through the flexible membrane cover 38 and is configured for pneumatic communication with the vacuum pump 34 through the vacuum tube 37. The evacuation passage 60 includes a rearwardly extending nipple 64 which extends through the rigid frame 22a of the flexible membrane cover 22 and presenting a central aperture 62 in a flanged support 61. The flanged support 61 provides grounded connectivity for the static neutralizer 48 to assist in equalizing the static charge between the support substrate 30 and the flexible membrane cover 38. The flanged support 61 also includes an upper protrusion 63 which presses against the flexible membrane cover 38.

Generally, the evacuation passage 60 presents a pneumatic passage which extends along the static neutralizer 48. The pneumatic passage provides for pneumatic communication between the exposing chamber 21 and the vacuum source 34 during deflation of the flexible membrane cover 38. As the flexible membrane cover 38 is deflated around the support substrate 30, the area surrounding the support substrate 30 becomes obstructed. The evacuation passage 60 provides for continued suction around the support substrate 30 as the flexible membrane cover 38 is deflated. The evacuation passage 60 maintains pneumatic communication with the exposing chamber 21 as the flexible membrane cover 38 is deflated by the suction source 34, providing improved surface contact with the support substrate 30. Generally, better surface contact between the flexible membrane cover 38 and the support substrate 30, allows for improved exposure by the LED array 40. This may also lead to less undercutting of the emulsion on the support substrate 30. Maintaining the pneumatic passageway from the support substrate 30 during suction, compresses the exposing chamber 21 and provides for improved contact between the flexible membrane cover 38 and the support substrate 30.

The lower receptacle 45 provides sufficient electrical connections for electrical communication between the LED array 40 and the controller 42. A deflector 29 generally surrounds the lower receptacle 45 extending upwardly towards a glass exposing area 26. The glass exposing area 26 is a generally transparent planar support which receives the support substrate 30 and allows for transmission of the UV radiation from the LED array 40. The deflector 29 illustrated in FIG. 1 is angled up towards the glass exposing area 26.

The LED array 40 generally emits UV energy towards the glass exposing area 26 for exposing a photosensitive emulsion to the UV radiation to treat which may include but is not limited to one or more of the following: curing, fixing, oxidizing, polymerizing or affecting a desired change to the photosensitive emulsion. In one embodiment, the LED array 40 is positioned a distance from the support substrate 30 for exposing the emulsified material 33 contained by the support substrate 30 to UV energy. At a distance, the LED array 40 provides a single point light source for illuminating the emulsified material 33 with UV energy.

The LED array 40 is illustrated in FIGS. 2-4 and is centrally surrounding by the deflector 29 and has a generally symmetrical face for presenting a plurality of LEDs 40a to generate sufficient UV energy. The LED array 40 is configured for removable receipt by the lower receptacle 45 with sufficient electrical and mechanical connections to operably energize the LED array 40.

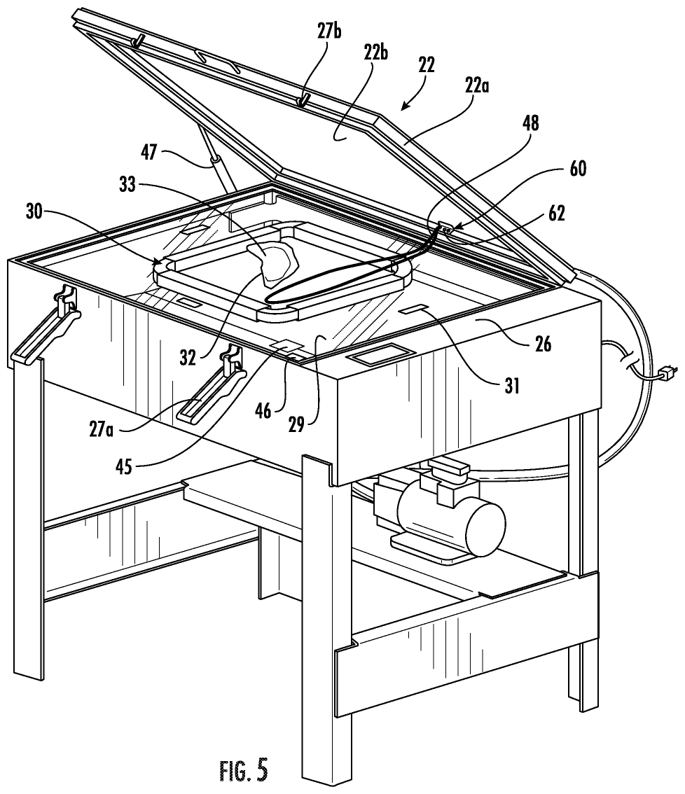

In addition, a LED driver 52 selectively powers the LED array 40 through traditional electrical circuitry allowing all LEDs 40a to be energized all at once or in a programmed manner. The LED driver 52 is in electrical communication with the controller 42 utilizing standard electrical connections and devices. For example, the embodiment illustrated in FIG. 4 includes a first temperature sensor 53 and a second temperature sensor 54. Alternatively, a thermostat, temperature monitor or temperature controller or any combination of these may be used to provide temperature input data for use in operating the LED array 40. The temperature sensors may be wired or wirelessly connected to the controller 42, the LED array 40 and any cooling devices, like fans or blowers (not shown).

In one operational embodiment of the LED array 40 depicted in FIG. 2, the individual UV LEDs 40a are grouped together and wired in series to each of the other UV LEDs 40a in that grouping. The grouping of LEDs (grouped LEDs) 40b are then connected in parallel to the electrical terminal 45a. The LED driver 52 provides sufficient power to energize the LEDs 40a wired in series as a grouping, grouped LEDs 40b on the LED array 40.

In operation, the energizing of the LEDs 40a generates a high amount of energy, of that a substantial percentage is converted to excess waste heat which results in an increased thermal temperature. To help lower the increased temperature, the LED array 40 includes various heat absorption materials and devices. In addition, the controller 42 may include various sensors and cooling devices to help maintain or lower the operating or ambient temperature.

An operational embodiment of an exemplary cooling process, utilizes a first temperature sensor 53 and a second temperatures sensor 54 in communication with the controller 42. Once the temperature as detected by a first temperature sensor 53 reaches an initial threshold, the controller 42 may initiate a cooling device like a fan (not shown). Upon detecting a second temperature threshold, the controller 42 may initiate shut-down of the UV LED array 40 while maintaining operation of the cooling device (not shown) until the desired temperature is obtained. In addition, the controller 42 may generate an alert on the control panel 43 and indicate the temperature threshold or otherwise generate an alert on the display 44 associated with the control panel 43.

The LED array 40 can have between 50 and 500 LEDs 40a, but the embodiment illustrated in FIG. 2, includes approximately 300 LEDs 40a. In one exemplary embodiment, the LED array 40 can arrange the individual LEDs 40a into groups or clusters (referred to herein as grouped LEDs 40b). By way of example, the grouping of LEDs 40a may be based on various characteristics including, but not limited to, the LED wavelength, color, temperature ratings, types, location, distance, spacing, size, and LED type. Generally, the LED array 40 has a plurality of grouped LEDs 40b and each grouped LED 40b has a plurality of LEDs 40a. The LED array 40 depicted in FIG. 2 is generally symmetrical and can be removed from the lower receptable 45 and replaced as needed with the same or different LED array. Alternatively, the LED array 40 may include a plurality of LEDs 40a arranged asymmetrically or intermittingly, as desired.

The grouped LEDs 40b depicted in FIG. 2 is arranged in rows or groups of rows, with each grouping having similar characteristics. By way of example, in one embodiment, each of the LEDs 40a connected as a group into a grouped LED 40b may emit UV radiation at the same or similar wavelength, amplitude, shape, power, etc. In one embodiment, each of the grouped LEDs 40b on the LED array 40 emits a band of peak wavelengths, between 330 nm and 420 nm.

The grouped LEDs 40b may be adjacently spaced along the face of the LED array 40 or they may be alternated with different LEDs arranged randomly or in a pattern. Alternatively, the grouped LEDs 40b may be placed intermittingly around the face of the LED array 40. In operation, the controller 42 is electrically connected to the LED array 40 via the LED driver 52. In one embodiment, the controller 42 is connected to each grouped LED 40b in a way to allow for controlled operation of the grouped LEDs 40b to provide the desired UV radiation directed towards the glass exposing area 26. For example, the controller 42 may operate all grouped LEDs 40b together or independently based on a programmed sequence such as a timed sequence, delaying some or keeping some grouped LEDs 40b operational for a longer time period.

An embodiment of the control panel 43 with the display 44 in communication with the controller 42 is illustrated in FIGS. 1, 5-8. Generally, the controller 42 is in operable communication with the vacuum pump 35, the LED array 40 and the latch sensor 46 which includes a first side 46a and a second side 46b, the first side 46a and second side 46b are configured to determine the current position of the flexible membrane cover 38. The latch sensor 46 can be used by the controller 42 to limit operation while the flexible membrane cover 38 is in an open or undetermined position, for example. In addition, the controller 42 may utilized storage or on board or local memory for storage of a computerized instructions which may be accessed or configured using the control panel 43 associated with the exposing unit 20, or it can be programmed directly using a cable (not shown) inserted or wired to the controller 42 or with the use of a removeable memory card (not shown) inserted into the controller 42. The controller 42 may also include a microprocessor 41 to help run the program to operate the LED array 40 and the vacuum pump 35.

In general, the exposure unit 20 is configured for receipt of the support substrate (metal housing) 30. The support substrate 30 is a generally planar support with a porous surface which receives a photosensitive emulsion which surrounds or has an embedded stencil or mask which operably presents a transparent and non-transparent region after the photosensitive emulsion is subject to sufficient UV radiation from the LED array 40. The support substrate 30 receives the photosensitive emulsion and supports it during radiation. Generally, the support substrate 30 is electrically neutralized by the static neutralizer 48. To assist alignment of the support substrate 30, a plurality of markings or indicia may be provided on the glass exposing area 26 for desired alignment of the support substrate 30 within the exposure unit 20 for irradiation by the LED array 40.

The flexible membrane cover 22 is generally rectangular and configured for pivotal operation with the use of an operator 47 located near the rear of the flexible membrane cover 22. Although the operator 48 is depicted as a generally telescopic pneumatic member the flexible membrane cover 22 may use various operators, struts, hinges or moveable members for pivotal movement of the flexible membrane cover 22. The flexible membrane cover 22 depicted in FIGS. 1, 5-8 includes a rigid rectangular frame 22a with a flexible membrane 22b extending between the rigid frame 22a.

The flexible membrane cover 22 depicted in FIG. 1 includes the contact sensor 46 for detecting the position of the flexible membrane cover 22. By way of example, the contact sensor 46 may help determine if the flexible membrane cover 22 is in the closed orientation or open orientation during operation. A pair of latches 27 extend along the front of the exposure unit 20 with a lower portion 27a extending along the sidewall 20b and an upper portion 27b associated with the rigid frame 22a of the flexible membrane cover 22. The lower portion 27a is configured for pivoted operation to allow for closure of the flexible membrane cover 22 towards the exposure unit 20. The pair of latches 27 depicted in FIG. 1, provides for leveraged operation of the latches 27 to seal or compress the flexible membrane cover 22 onto the sidewall 20b of the exposure unit 20 for a sealed closure.

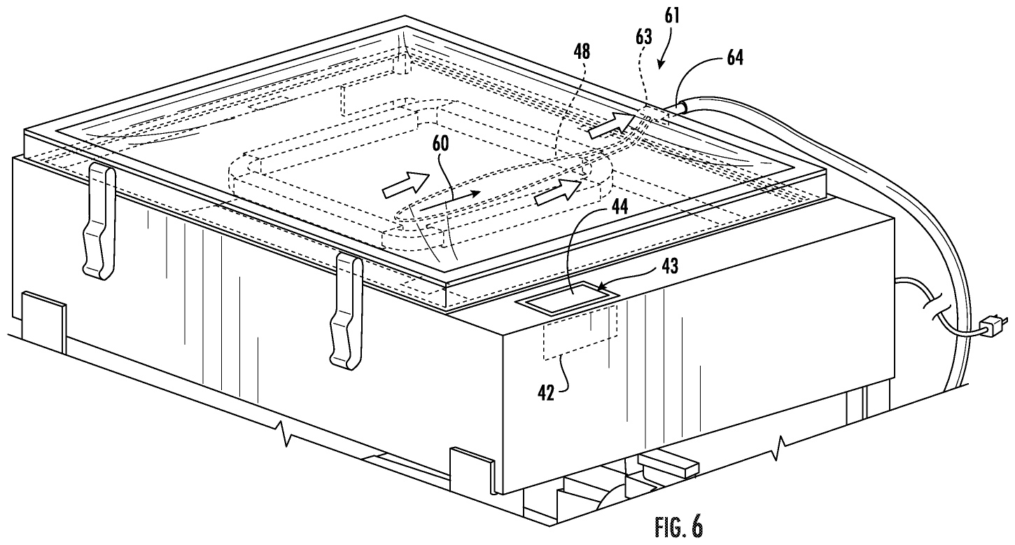

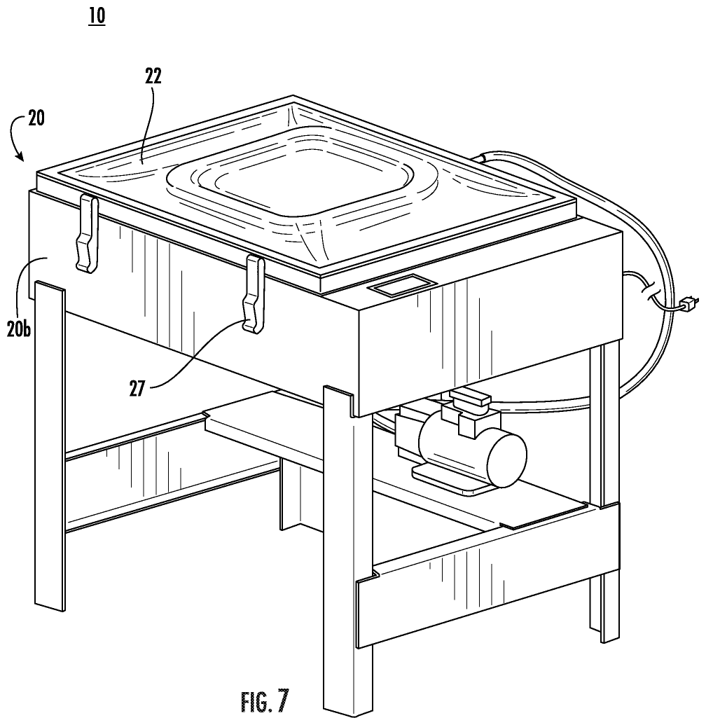

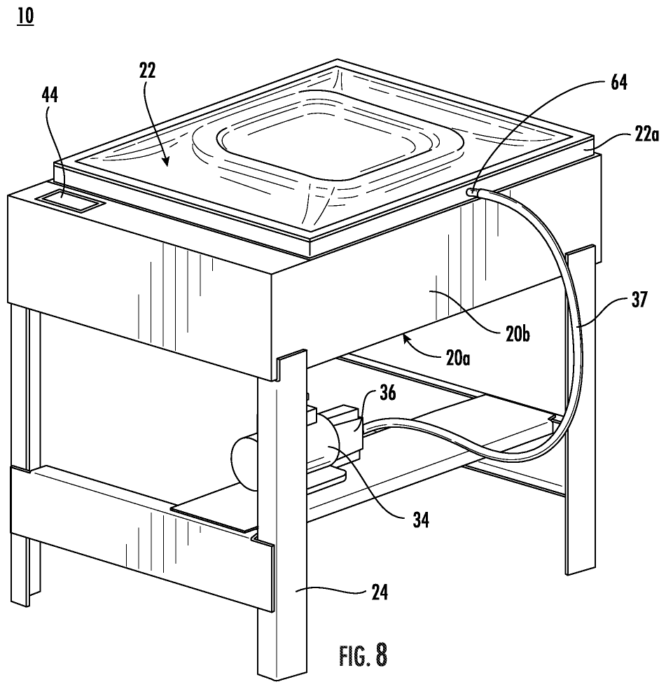

According to a program or routine stored in memory or transmitted to the controller 42, through for example, the control panel, operation of the UV curing assembly 10 may be configured. For example, if the controller 42, in electrical communication with the contact or latch sensor 46, is unable to verify the exposure unit 20 is closed, the controller 42 may limit operation of the vacuum pump 34, the LED array 40 and/or the exposure unit 20. The embodiment of the latches 27 include a first latching part 27a and a complementary second latching part 27b which is pivotally secured by the first latching part 27a. The latches 27 are depicted in FIGS. 6-7 in the rotated, closed position and configured to compress or sealingly secure the exposure unit 20.

It is to be understood that while certain forms of the present invention have been illustrated and described herein, it is not to be limited to the specific forms or arrangement of parts described and shown.

What is claimed and desired to be secured by Letters Patent:

1. An improved UV curing assembly comprising:
an exposure unit configured for receiving a support substrate;
a support structure extending from said exposure unit and configured for housing a vacuum source;
a flexible membrane cover configured to cover said exposure unit and in pneumatic communication with said vacuum source;
a lower receptacle;
said lower receptacle configured for receiving an LED array;
said LED array having a first terminal and a second terminal;
a first plurality of LEDs having a first characteristic connected in series;
a second plurality of LEDs having a second characteristic connected in series; and
said first plurality of LEDs and said second plurality of LEDs connected in parallel to said first terminal and said second terminal wherein said first plurality of LEDs and said second plurality of LEDs are capable of treating a material placed on said support substrate.

2. The improved UV curing assembly of claim 1 wherein said LED array is in further communication with a controller which operable controls said LED array and said vacuum source whereby said flexible membrane cover is at least partially deflated while said LED array is energized.

3. The improved UV curing assembly of claim 1 further comprising a static neutralizer which extends between said flexible membrane cover and said support substrate.

4. The improved UV curing assembly of claim 3 wherein said static neutralizer presents a pneumatic passageway which extends from the support substrate through the flexible membrane cover to said vacuum source.

5. The improved UV curing assembly of claim 2 wherein said exposure unit further comprises a control panel in operable communication with said controller.

6. The improved UV curing assembly of claim 2 wherein said exposure unit further comprises a latch sensor in communication with said controller.

7. The improved UV curing assembly of claim 2 wherein said flexible membrane cover is at least partially deflated while said LED array is energized.

8. The improved UV curing assembly of claim 1 wherein said first plurality of LEDs are arranged in rows and said second plurality of LEDs are arranged in rows spaced next to said first plurality of LEDs for emitting a band of UV light between 330 nm and 420 nm capable of treating said material placed on said support substrate.

9. The improved UV curing assembly of claim 1 wherein said LED array is positioned a prescribed distance from said support substrate.

10. The improved UV curing assembly of claim 9 wherein said LED array provides a single point light source for treating said support substrate.
